(19) United States
(12) Patent Application Publication
(10) Pub. No.: US 2021/0367706 A1
(43) Pub. Date: Nov. 25, 2021

(54) DEVICE COMMUNICATION INTERPRETATION BASED ON PROCESS STATE

(71) Applicant: HEWLETT-PACKARD DEVELOPMENT COMPANY, L.P., Spring, TX (US)

(72) Inventors: Joshua Schiffman, Bristol (GB); Joan Varvenne, Bristol (GB)

(21) Appl. No.: 16/606,357

(22) PCT Filed: May 21, 2018
(86) PCT No.: PCT/US2018/033720

§ 371 Date: Oct. 18, 2019

(51) Int. Cl. H04L 1/00; H04L 1/16; H04L 1/20

(52) U.S. Cl. CPC H04L 1/0033; H04L 1/201; H04L 1/1628; H04L 1/1685

(57) ABSTRACT

Examples disclosed herein relate to interpreting a device communication based on process state. In one implementation, first electronic device transmits a request for data to a second electronic device. For example, the second electronic device may not include a capability to independently send a message to the first electronic device. The first electronic device may determine based on stored process state information whether a response received from the second electronic device is associated with at least one of an acknowledgment of previously data sent, an amount of data available to transmit to the first electronic device, and the available data.

### BACKGROUND

Communication protocols may be used for devices, such as IoT devices to communicate with one another. One example, of a communication protocol is the GATT protocol for Bluetooth Low Energy. The GATT data services protocol allows a central device to drive communication with a slave peripheral device.

### BRIEF DESCRIPTION OF THE DRAWINGS

The drawings describe example embodiments. The following detailed description references the drawings, wherein:

FIG. 1 is a block diagram illustrating one example of a computing system to interpret a device communication based on a process state.

FIG. 2 is a flow chart illustrating one example of a method to interpret a device communication based on a process state.

FIG. 3 is a flow chart illustrating one example of a method to interpret a device communication based on a process state.

FIG. 4 is a diagram illustrating one example of communication between a first and second electronic device.

### DETAILED DESCRIPTION

In one implementation, a central device communicates with a slave peripheral device, and the central device interprets the meaning of a response from the slave peripheral device based on stored process state information indicating a current state in the process. For example, the slave peripheral device may be unable to initiate communication with the central device, and communication from the slave peripheral device may be limited to responses to communications from the central device. The central device may store information about the state of communication between the central and peripheral devices to interpret a response from the peripheral device.

As an example, the central device may send data to the slave peripheral device, and a response, such as within a particular time period of sending the data and prior to another communication from the central device, may be interpreted to indicate error information about receipt of the data by the slave peripheral device. As another example, a second response from the slave peripheral device may be interpreted to indicate whether data frames are ready to be read from the slave peripheral device. For example, the central device may poll the slave peripheral device for information and associate the response with a number of frames to read from the slave peripheral device if the process state does not indicate another type of response outstanding.

A communication protocol involving stored state information used by a central device for interpreting communications with a slave device may be useful for communication protocols driven by central devices. For example, the communication protocol may be a layer on top of another IoT protocol. IoT communication protocols may allow communication without a device pairing and have a configuration where a central device drives communication with slave devices that host services. As an example, Bluetooth Low Energy uses a GATT data transfer services protocol that includes a central device driving communication. As a result, error detection, encryption, and other data services may be difficult to run on top of the protocol. In addition, the GATT protocol uses frame limited messages, and the state machine may allow the central device to track messages sent over multiple frames. Adding the communication protocol to interpret responses may add reliability to a communication protocol. Streaming and cryptographic protocols may rely on reliability, such as error acknowledgment.

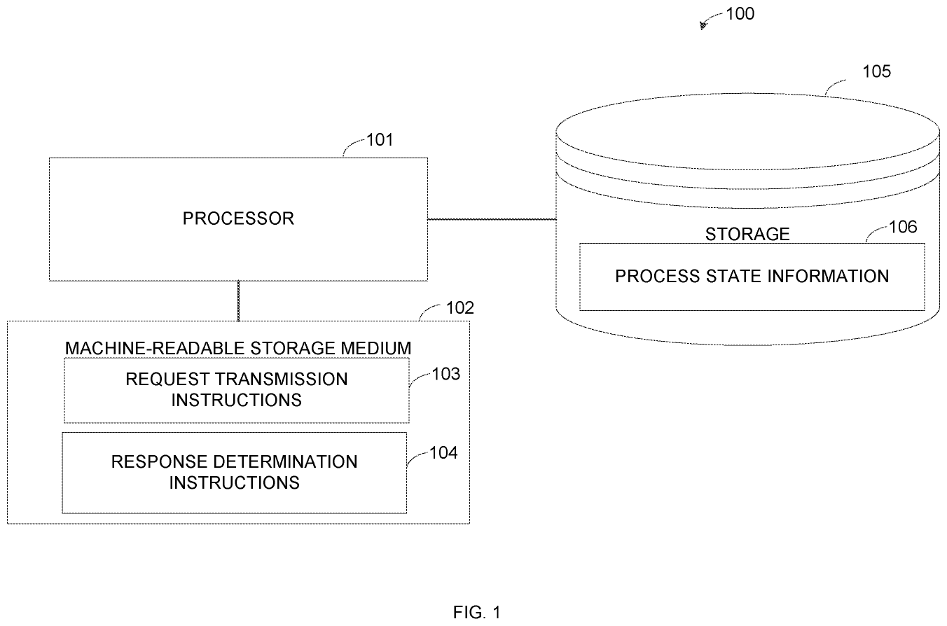

FIG. 1 is a block diagram illustrating one example of a computing system 100 to interpret a device communication based on a process state. The computing system 100 includes a processor 101, machine-readable non-transitory storage medium 102, and a storage 105. The processor 101 may be associated with a first electronic device, and the computing system 100 may include a second electronic device that is a peripheral to the first electronic device. The first electronic device may be a central device, and the second electronic device may be a slave peripheral device. The first and second electronic devices may be IoT devices that communicate using a wireless protocol, such as Bluetooth Low Energy, Thread, and/or Zigbee. The computing system 100 may include any suitable number of electronic devices, such as where the first electronic device communicates with multiple peripheral devices and stores process state information associated with the different communication workflows.

The storage 105 may be any suitable storage accessible by the processor 101. For example, the storage 105 may be part of the same electronic device as the processor 101 or may be accessed by the processor 101 via a network. The storage 105 may store process state information 106. The process state information 106 may indicate a process state related to a last requested communication and a last received response. The process state information 106 may store process workflow information associated with communications with multiple devices, such as where the process state is different for communication with a second electronic device than with a third electronic device.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include request transmission instructions 103 and response determination instructions 104.

The request transmission instructions 103 may include instructions to transmit a request for data to a second electronic device. The second electronic device may not, include a capability to independently send a message to the first electronic device. For example, the processor may periodically poll the second electronic device. The first electronic device may request data from the second electronic device at any suitable interval, such as based on a current state in the process workflow and/or at regular intervals.

The requests may be transmitted in any suitable manner. In one implementation, the request is transmitted as a read request associated with an IoT protocol, such as Bluetooth Low Energy or Zigbee.

The response determination instructions 104 may include instructions to determine whether a response received from the second electronic device is associated with an acknowledgment of previous data sent, an amount of data available, and/or data frames based on the stored process state information. For example, the process state information 106 may indicate that unacknowledged data was sent from the first electronic device to the second electronic device, and the response may be interpreted to include error information from the second electronic device. For example, the payload of the communication may indicate identification information of data frames received by the second electronic device, such as frame numbers. The processor 101 may compare the frames received to stored information related to the frames sent to determine if any of the data frames were not received. The processor 101 may re-send data frames not received.

The response from the second electronic device may be interpreted to indicate a communication or an indication that no data is ready to send. In one implementation, the processor 101 interprets the response to indicate, an amount of data to be read from the second electronic device. For example, if the process state information 106 indicates that error acknowledgment or other response is not outstanding, the received response may be associated with an amount of data to be retrieved from the second electronic device. In one implementation, the response is related to an amount of data to be read from the second electronic device, such as a payload size or number of data frames. The processor 101 may store in the information about the amount of data in the storage 105.

In one implementation, the process state information 106 indicates that an amount of data is to be received, and the processor interprets a response to a read request as the available data to be read. The processor 101 may send requests to retrieve the available data, such as a number of requests to receive the amount of data based on a frame limit size for a protocol for communication with the second electronic device. In some cases, the processor 101 sends multiple read requests to retrieve the available data. The response from the second electronic device may be interpreted to be data intended to be read by the first electronic device

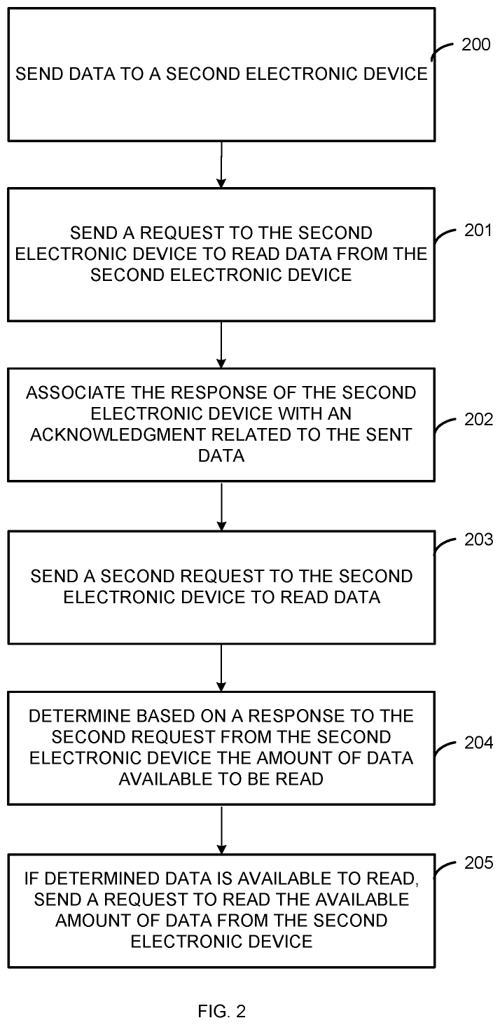

FIG. 2 is a flow chart illustrating one example of a method to interpret a device communication based on a process state. For example, a first electronic device may send a read request to a second electronic device and interpret the response based on stored information related to a process state in a communication workflow between the first and second electronic device. The second electronic device may be unable, to initiate communication with the first electronic device, and the first and second electronic devices may communicate via an IoT protocol, such as Bluetooth Low Energy, Thread, or Zigbee. The method may be implemented, for example, by the computing system 100 of FIG. 1.

Beginning at 200, a first electronic device sends data to a second electronic device. For example, the first electronic device may be a central device in an IoT computing system, and the second electronic device may be a slave peripheral device to the first device. The first electronic device may send the data as a write characteristic message using an IoT protocol message. The first electronic device may send a write request to the second electronic device. The write request may include multiple data frames with each data frame having an identifier. The first electronic device, may store information about the identifiers and associated data of the sent data frames.

The first electronic device may determine data is to be sent and segment the data ready to be sent into frames that fit into a frame size limit, such as a 20 byte frame size. The individual frames may include a header with identifier information about the frame within the sequence, such as a frame number. The first electronic device may initially send a frame that indicates the length of the data segment, such as the number of data frames, and an acknowledgment window. For example, the size of a frame may be limited, and an acknowledgment window may be used such that more of the frame size is not dedicated to acknowledgment. After the initial frame, the first electronic device may send the data frames up to the window size.

Continuing to 201, the first electronic device sends a request to the second electronic device to read data from the second electronic device. The first electronic device may send a request to the second electronic device, such as a read characteristic using a GATT protocol message. The first electronic device may send a read request at regular intervals and/or based on a current communication workflow state.

In response to the request, the second electronic device may send available data to be sent and/or information about data to be sent if it has queued data to be transmitted to the first electronic device. In one implementation, the second electronic device sends data receipt acknowledgment to the first electronic device. For example, the second electronic device may send information about the received frame identifiers, The second electronic device may send the response as a write command, such as a write characteristic.

Continuing to 202, the first electronic device associates the response of the second electronic device with an acknowledgment related to the sent data. For example, the first electronic device may access stored data related to the communication workflow between the first and second electronic device to determine that the response is associated with error information. For example, the stored workflow information may indicate that unacknowledged data was transmitted to the second electronic device. In one implementation, the first electronic device compares a list of data frame identifiers in the response to a stored list of data frame identifiers associated with data sent to the second electronic device. The first electronic device may re-send any data frames not acknowledged, and the process of interpreting a response as indicating an acknowledgment may continue until the set of data frames sent are acknowledged.

Continuing to 203, the first electronic device sends a second request to the second electronic device to read data. For example, the electronic device may periodically poll the second electronic device to read information. The read request may be intended to query whether the second electronic device has data to send to the first electronic device. The second electronic device may be unable to initiate communication with the first electronic device, and the first electronic device may send read requests to the second electronic device to determine if the second electronic device is ready to send data. For example, the same read request may be sent whether the response is expected to be related to data frames to write or acknowledgment information.

Continuing to 204, the first electronic device determines based on a response to the second request from the second electronic device the amount of data available to be read. For example, the first electronic device may access stored communication workflow information that indicates that an acknowledgment is not outstanding and that an amount of data to be read has not been indicated. In one implementation, a 0 or other response indicates that the second electronic device does not have data to send. In response, the first electronic device may wait and send a communication to the second electronic device again after a particular time interval.

In one implementation, a response received by the first electronic device indicates an amount of data available to be read. For example, the response may indicate a number of data frames or bytes ready to be sent by the second electronic device.

Continuing to 205, if determined data is available to read, the first electronic device sends a request to read the available amount of data from the second electronic device. In one implementation, the first electronic device sends multiple read requests where the amount of data to be read is greater than the payload allowed by a data frame in the communication protocol.

The second electronic device may prepare a data sequence to send to the first electronic device, such as by dividing the data into frames up to a frame size limit. The second electronic device may continue to send the next frame with each read request from the first electronic device, and the first electronic device may determine the number of read requests based on the information related to the amount of data to be sent. The second electronic device may return a waiting frame until receiving an acknowledgment frame from the first electronic device.

The workflow may be reset with a start or sync message from the first electronic device to the second electronic device when the next communication workflow is initiated.

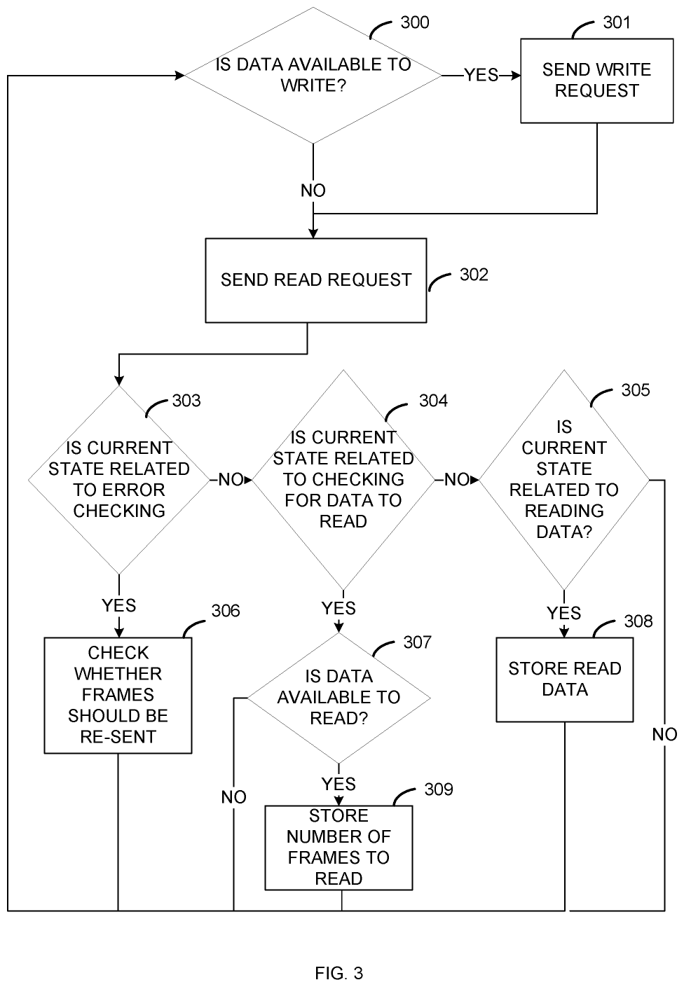

FIG. 3 is a flow chart illustrating one example of a method to interpret a device communication based on a process state. The method may be implemented, for example, by the computing system 100 of FIG. 1. The method may be implemented by a first electronic device that communicates with a second peripheral electronic device. The second electronic device may be incapable of initiating communication with the first electronic device.

Beginning at 300, the first electronic device determines if data is available to write. For example, the first electronic device may determine if there is information in a storage to be transmitted to a second electronic device. The first electronic device may communicate with multiple peripheral devices and have different information to communicate with each of them.

If data is available to write, the method continues to 301, and the first electronic device sends a write request to transmit the data to the second electronic device, The write request may include identifier information related to the data sent, such as data frame numbers, that may be used to identify the sets of data sent. The first electronic device may store information related to a state in a communication workflow indicating whether data was sent to be acknowledged. The first electronic device updates stored communication workflow information to indicate that a response from the second electronic device is to be interpreted as error checking information. In one implementation, the first electronic device sends multiple write requests due the data size being larger than a frame size limit.

After the write request or if no data is available to write, the method continues to 302, and the first electronic device sends a read request. For example, the first electronic device may periodically send a read request to the second electronic device in order to receive any messages from the second electronic device.

Continuing to 303, the first electronic device determines if the current state is related to error checking. If the current state is related to error checking, the method continues to 306, and the first electronic device determines whether frames should be re-sent. For example, the first electronic device may compare information about received frame numbers from the response from the second electronic device to stored information about data frames sent, The first electronic device may re-send unacknowledged frames by continuing to 300 and updating the list of data to send to be limited to the unacknowledged frames.

If the current state is not related to error checking, the method continues to 304, and the first electronic device determines if the current state is related to checking for data to read. For example, the response from the second electronic device may be related to an amount of data for the first electronic device to retrieve. If the first electronic device determines that the current state is related to checking for an amount of data to read, the method continues to 307, and the first electronic device determines an amount of data to read based on the response. If the response indicates that no data is available to read, the method continues to 300. If the response indicates that data is available to read, the method continues to 309, and the first electronic device stores information about the number of data frames to read. If the response indicates an amount of data greater than zero, the first electronic device may store information about the amount of available data to read, such as number of frames or bytes. After storing information about the amount of data, the method continues to 300.

If the current state is not related to determining an amount of data to read, the method continues to 305 and determines if the current state is related to reading data. For example, the electronic device may access stored communication workflow information to determine a current state in the workflow. The current state may indicate that the second electronic device has indicated that it has data to send, such as an amount of indicated available data. Continuing to 308, the first electronic device stores received data. In some cases, the amount of data that the second electronic device has to send may exceed the size of a single message, and, the first electronic device may read the frame and update the amount of remaining data to read in subsequent responses. The method continues to 300 for an additional iteration.

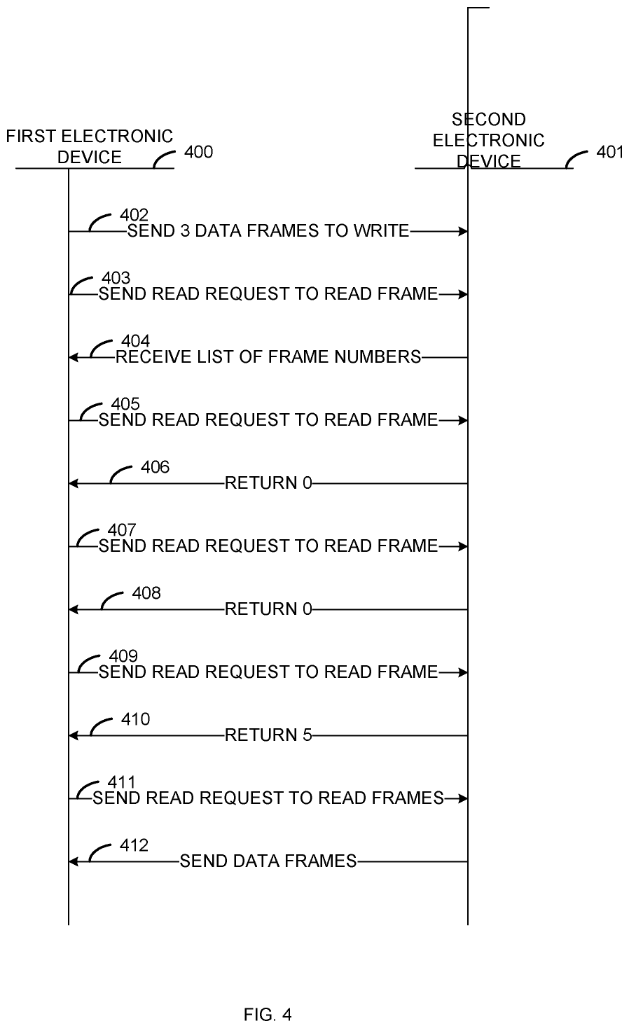

FIG. 4 is a diagram illustrating communication between a first electronic device 400 and a second electronic device 401. The first electronic device 400 may be a central device responsible for driving communication with the second electronic device 401.

At 402, the first electronic device 400 sends 3 data frames to write to the second electronic device 401. The second electronic device 401 may read the 3 received data frames.

At 403, the first electronic device 400 sends a read request to the second electronic device 401. For example, the first electronic device 400 may periodically send a read request to the second electronic device 401 to determine if the second electronic device 401 has data to send.

At 404, the first electronic device 400 receives a list of frame numbers from the second electronic device 401. For example, the first electronic device 400 may receive a response to the read request, and the first electronic device 400 may access stored process workflow data that indicates that a response should be associated with error checking information. The first electronic device 401 may interpret the response to include identifier information associated with acknowledged frames that were received by the second electronic device 401.

At 405, the first electronic device 400 sends a read request to the second electronic device 401. For example, the first electronic device 400 may periodically poll the second electronic device 401.

At 406, the first electronic device 400 receives a response from the second electronic device 401 indicating that there is no data to send. For example, the payload may indicate 0 bytes are available. The first electronic device 400 may determine to interpret the response as an amount of data available to read based on stored workflow information indicating that the workflow is not in an active step of retrieving data from the second electronic device 401.

At 407, the process may repeat, and the first electronic device 400 again sends a read request to the second electronic device 401 and at 408, the first electronic device 400 receives a response indicating that there is no data to read.

At 409, the first electronic device 400 again polls the second electronic device 401.

At 410, the first electronic device 400 receives a response indicating that 5 frames are ready to be sent by the second electronic device 401.

At 412, the second electronic device 401 sends the 5 data frames to the electronic device 400. The first electronic device 400 may compare the received data frames to the information about expected data frames and send information to the second electronic device 401 about data that was not received. For example, the stored communication workflow information may include information about expected data frames. A method including interpreting received response based on stored workflow information may allow for a reliability layer far use with a communication where a device is not able to initiate communication.

1. A computing system, comprising:
a storage to store process state information;
a processor associated with a first electronic device to:
transmit a request for data to a second electronic device, wherein the second electronic device does not include a capability to independently send a message to the first electronic device; and
determine based on stored the stored process state information whether a response received from the second electronic device is associated with at least one of an acknowledgment of previously data sent, an amount of data available to be transmitted to the first electronic device, and available data.

2. The computing system of claim 1,
wherein transmitting a request comprises transmitting multiple requests to the second electronic device; and
wherein the processor is further to send a request to read data frames from the second electronic device when a response to at least one of the multiple requests indicates that data is available to read from the second electronic device.

3. The computing system of claim 1, wherein the processor is further to:
transmit data frames to a second electronic device; and
wherein a response to a subsequent request for data is associated with error information related to the transmitted data frames.

4. The computing system of claim 1, wherein the processor is further to determine data frames to reseed based on a comparison of the response to the request used to determine error information to the process state information indicating the number of sent data frames.

5. The computing system of claim 1, wherein transmitting a request comprises transmitting a request over Bluetooth Low Energy.

6. A method, comprising:
sending, by a first electronic device, data to a second electronic device;
sending a request to the second electronic device to read data from the second electronic device;
associating the response of the second electronic device with an acknowledgment related to the sent data;
sending a second request to the second electronic device to read data;
determine based on a response to the second request from the second electronic device the amount of data available to be read; and
if determined data is available to read, send a request to read the available amount of data from the second electronic device.

7. The method of claim 6, further comprising transmitting, by the second device, the available data to the first electronic device.

8. The method of claim 6, wherein determining based on the response comprises determining that data is available if the response comprises information about a number of data frames available to be sent.

9. The method of claim 6, wherein sending a request to read the available amount of data sending multiple read requests to retrieve the number of available data frames.

10. The method of claim 6, wherein sending data to the second electronic device comprises sending a write characteristic to the second electronic device and wherein sending a request to the second electronic device to read comprises sending a read characteristic to the second electronic device.

11. The method of claim 6, wherein sending data to the second electronic device comprises sending a number of data frames and the data frames.

12. The method of claim 6, further comprising:
determining that the received acknowledgement does not include the full set of data frames sent to the second electronic device; and
resending to the second electronic device data frames not included in the acknowledgement.

13. A machine-readable non-transitory storage medium comprising instructions executable by a processor to:
communicate with a slave peripheral device; and
interpret the meaning of a response from the slave peripheral device based on stored process state information indicating a current state in the process.

14. The machine-readable non-transitory storage medium of claim 13, wherein instructions to communicate with the slave peripheral device comprise instructions to send data to the slave peripheral device and wherein a response is interpreted to indicate error information about receipt of the data by the slave peripheral device.

15. The machine-readable non-transitory storage medium of claim 13, wherein instructions to communicate with the slave peripheral device comprise instructions to poll the slave peripheral device for information to send and wherein a response is interpreted to indicate whether data frames are ready to be read from the slave peripheral device.
